(19) United States
(12) Patent Application Publication
(10) Pub. No.: US 2023/0300644 A1
(43) Pub. Date: Sep. 21, 2023

(54) APPARATUS AND METHODS OF BEAM FAILURE DETECTION MECHANISM FOR ENHANCED PDCCH WITH MULTIPLE TRANSMISSIONS

(71) Applicant: LENOVO (BEIJING) LIMITED, Beijing (CN)

(72) Inventors: Yi Zhang, Beijing (CN); Chenxi Zhu, Fairfax, VA (US); Bingchao Liu, Beijing (CN); Wei Ling, Beijing (CN)

(21) Appl. No.: 18/016,554

(22) PCT Filed: Jul. 17, 2020
(86) PCT No.: PCT/CN2020/102742

§ 371 Date: Jan. 17, 2023

(51) Int. Cl. H04W 24/08; H04W 72/232

(52) U.S. Cl. CPC H04W 24/08; H04W 72/232

(57) ABSTRACT

Apparatus and methods of beam failure detection mechanism for enhanced PDCCH with multiple transmissions are disclosed. The apparatus includes: a processor that determines abeam failure detection resource combination, or abeam failure detection resource, for detecting beam failure of multiple transmissions of Physical Downlink Control Channel (PDCCH) for a Downlink Control Information (DCI), wherein the beam failure detection resource combination comprises a plurality of beam failure detection resources; and a receiver that receives signals from at least one of the beam failure detection resources; wherein the processor further determines a link quality based on measurements of the signals received from the at least one of the beam failure detection resources, and a threshold based on a hypothetical PDCCH with multiple transmissions using one or more Transmission Configuration Indication (TCI) states; and the processor further generates a beam failure evaluation report based on the link quality and the threshold.

### FIELD

The subject matter disclosed herein relates generally to wireless communication and more particularly relates to, but not limited to, apparatus and methods of beam failure detection mechanism for enhanced Physical Downlink Control Channel (PDCCH) with multiple transmissions.

### BACKGROUND

The following abbreviations and acronyms are herewith defined, at least some of which are referred to within the specification: Third Generation Partnership Project (3GPP), 5th Generation (5G), New Radio (NR), 5G Node B/generalized Node B (gNB), Long Term Evolution (LTE), LTE Advanced (LTE-A), E-UTRAN Node B/Evolved Node B (eNB), Universal Mobile Telecommunications System (UMTS), Worldwide Interoperability for Microwave Access (WiMAX), Evolved UMTS Terrestrial Radio Access Network (E-UTRAN), Wireless Local Area Networking (WLAN), Orthogonal Frequency Division Multiplexing (OFDM), Single-Carrier Frequency-Division Multiple Access (SC-FDMA), Downlink (DL), Uplink (UL), User Entity/Equipment (UE), Network Equipment (NE), Radio Access Technology (RAT), Receive or Receiver (RX), Transmit or Transmitter (TX), Physical Downlink Control Channel (PDCCH), Physical Broadcast Channel (PBCH), Block Error Rate (BLER), Bandwidth Part (BWP), Control Channel Element (CCE), Control Element (CE), Control Resource Set (CORESET), Cyclic Prefix (CP), Channel State Information (CSI), Channel State Information Reference Signal (CSI-RS), Downlink Control Information (DCI), Discontinuous Reception (DRX), Frequency Division Multiple Access (FDMA), Identification (ID), Information Element (IE), Media Access Control (MAC), Primary Cell (PCell), Resource Elements (RE), Resource-Element Group (REG), remaining minimum system information (RMSI), Radio Resource Control (RRC), Reference Signal (RS), Secondary Cell (SCell), Subcarrier Spacing (SCS), Synchronization Signal Block (SSB), Secondary Synchronization Signal (SSS), Transmit Receive Point (TRP), Frequency Range 1 (FR1), Frequency Range 2 (FR2), Synchronization Signal (SS), Transmission Configuration Indication (TCI), Technical Specification (TS), Quasi Co-Location (QCL), Primary Secondary Cell (PSCell), in/out of synchronization (IS/OOS).

In wireless communication, such as a Third Generation Partnership Project (3GPP) mobile network, a wireless mobile network may provide a seamless wireless communication service to a wireless communication terminal having mobility, i.e. user equipment (UE). The wireless mobile network may be formed of a plurality of base stations and a base station may perform wireless communication with the UEs.

The 5G New Radio (NR) is the latest in the series of 3GPP standards which supports very high data rate with lower latency compared to its predecessor LTE (4G) technology. Two types of frequency range (FR) are defined in 3GPP. Frequency of sub-6 GHz range (from 450 to 6000 MHz) is called FR1 and millimeter wave range (from 24.25 GHz to 52.6 GHz) is called FR2. The 5G NR supports both FR1 and FR2 frequency bands.

Enhancements on multi-TRP/panel transmission including improved reliability and robustness with both ideal and non-ideal backhaul between these TRPs (Transmit Receive Points) are studied. A TRP is an apparatus to transmit and receive signals, and is controlled by a gNB through the backhaul between the gNB and the TRP. A TRP may also be referred to as a transmitting-receiving identity, or simply an identity.

In current NR system, Physical Downlink Control Channel (PDCCH) is transmitted from a single TRP. With multiple TRPs, time-frequency resources for PDCCH transmission may be from multiple TRPs The spatial diversity may be exploited in addition to the time-frequency diversity. Enhanced Physical Downlink Control Channel (E-PDCCH) allows exploitation of the additional resources to improve PDCCH transmission reliability and robustness. Multiple transmissions of the E-PDCCH may be transmitted from a same TRP or some different TRPs.

### SUMMARY

Apparatus and methods of beam failure detection mechanism for enhanced PDCCH with multiple transmissions are disclosed.

According to a first aspect, there is provided an apparatus, including: a processor that determines a beam failure detection resource combination, or a beam failure detection resource, for detecting beam failure of multiple transmissions of Physical Downlink Control Channel (PDCCH) for a Downlink Control Information (DCI), wherein the beam failure detection resource combination comprises a plurality of beam failure detection resources; and a receiver that receives signals from at least one of the beam failure detection resources; wherein the processor further determines a link quality based on measurements of the signals received from the at least one of the beam failure detection resources, and a threshold based on a hypothetical PDCCH with multiple transmissions using one or more Transmission Configuration Indication (TCI) states; and the processor further generates a beam failure evaluation report based on the link quality and the threshold.

According to a second aspect, there is provided an apparatus, including: a transmitter that transmits signals over a beam failure detection resource combination, or a beam failure detection resource, for detecting beam failure of multiple transmissions of Physical Downlink Control Channel (PDCCH) for a Downlink Control Information (DCI), wherein the beam failure detection resource combination comprises a plurality of beam failure detection resources; and a receiver that receives a beam failure report that is generated based on a link quality and a threshold, wherein the link quality is determined based on measurements of signals received from the plurality of beam failure detection resources, and the threshold is determined based on a hypothetical PDCCH with multiple transmissions.

According to a third aspect, there is provided a method, including: determining, by a processor, a beam failure detection resource combination, or a beam failure detection resource, for detecting beam failure of multiple transmissions of Physical Downlink Control Channel (PDCCH) for a Downlink Control Information (DCI), wherein the beam failure detection resource combination comprises a plurality of beam failure detection resources; and receiving, by a receiver, signals from at least one of the beam failure detection resources; wherein the processor further determines a link quality based on measurements of the signals received from the at least one of the beam failure detection resources, and a threshold based on a hypothetical PDCCH with multiple transmissions using one or more Transmission Configuration Indication (TCI) states; and the processor further generates a beam failure evaluation report based on the link quality and the threshold.

According to a fourth aspect, there is provided a method, including: transmitting, by a transmitter, signals over a beam failure detection resource combination, or a beam failure detection resource, for detecting beam failure of multiple transmissions of Physical Downlink Control Channel (PDCCH) for a Downlink Control Information (DCI), wherein the beam failure detection resource combination comprises a plurality of beam failure detection resources; and receiving, by a receiver, a beam failure report that is generated based on a link quality and a threshold, wherein the link quality is determined based on measurements of signals received from the plurality of beam failure detection resources, and the threshold is determined based on a hypothetical PDCCH with multiple transmissions.

### BRIEF DESCRIPTION OF THE DRAWINGS

A more particular description of the embodiments will be rendered by reference to specific embodiments illustrated in the appended drawings. Given that these drawings depict only some embodiments and are not therefore considered to be limiting in scope, the embodiments will be described and explained with additional specificity and details through the use of the accompanying drawings, in which:

FIG. 1 is a schematic diagram illustrating a wireless communication system in accordance with some implementations of the present disclosure;

FIG. 2 is a schematic block diagram illustrating components of user equipment (UE) in accordance with some implementations of the present disclosure;

FIG. 3 is a schematic block diagram illustrating components of network equipment (NE) in accordance with some implementations of the present disclosure;

FIGS. 4A and 4B are schematic diagrams illustrating exemplary systems of multiple transmissions of PDCCH for a DCI using multiple TRPs in accordance with some implementations of the present disclosure;

FIG. 5 is a flow chart illustrating steps of beam failure detection mechanism for enhanced PDCCH with multiple transmissions by UE in accordance with some implementations of the present disclosure; and

FIG. 6 is a flow chart illustrating steps of beam failure detection mechanism for enhanced PDCCH with multiple transmissions by NE in accordance with some implementations of the present disclosure.

### DETAILED DESCRIPTION

As will be appreciated by one skilled in the art, aspects of the embodiments may be embodied as a system, an apparatus, a method, or a program product. Accordingly, embodiments may take the form of an all-hardware embodiment, an all-software embodiment (including firmware, resident software, micro-code, etc.) or an embodiment combining software and hardware aspects.

Furthermore, one or more embodiments may take the form of a program product embodied in one or more computer readable storage devices storing machine readable code, computer readable code, and/or program code, referred to hereafter as “code.” The storage devices may be tangible, non-transitory, and/or non-transmission.

Reference throughout this specification to “one embodiment,” “an embodiment,” “an example,” “some embodiments,” “some examples,” or similar language means that a particular feature, structure, or characteristic described is included in at least one embodiment or example. Thus, instances of the phrases “in one embodiment,” “in an example,” “in some embodiments,” and similar language throughout this specification may, but do not necessarily, all refer to the same embodiment(s). It may or may not include all the embodiments disclosed. Features, structures, elements, or characteristics described in connection with one or some embodiments are also applicable to other embodiments, unless expressly specified otherwise. The terms “including,” “comprising,” “having,” and variations thereof mean “including but not limited to,” unless expressly specified otherwise.

An enumerated listing of items does not imply that any or all of the items are mutually exclusive, unless expressly specified otherwise. The terms “a,” “an,” and “the” also refer to “one or more” unless expressly specified otherwise.

Throughout the disclosure, the terms “first,” “second,” “third,” and etc. are all used as nomenclature only for references to relevant devices, components, procedural steps, and etc. without implying any spatial or chronological orders, unless expressly specified otherwise. For example, a “first device” and a “second device” may refer to two separately formed devices, or two parts or components of the same device. In some cases, for example, a “first device” and a “second device” may be identical, and may be named arbitrarily. Similarly, a “first step” of a method or process may be carried or performed after, or simultaneously with, a “second step.”

It should be understood that the term “and/or” as used herein refers to and includes any and all possible combinations of one or more of the associated listed items. For example, “A and/or B” may refer to any one of the following three combinations: existence of A only, existence of B only, and co-existence of both A and B. The character “/” generally indicates an “or” relationship of the associated items. This, however, may also include an “and” relationship of the associated items. For example, “A/B” means “A or B,” which may also include the co-existence of both A and B, unless the context indicates otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of various embodiments are described below with reference to schematic flowchart diagrams and/or schematic block diagrams of methods, apparatuses, systems, and program products. It will be understood that each block of the schematic flowchart diagrams and/or schematic block diagrams, as well as combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions executed via the processor of the computer or other programmable data processing apparatus create a means for implementing the functions or acts specified in the schematic flowchart diagrams and/or schematic block diagrams.

The code may also be stored in a storage device that can direct a computer, other programmable data processing apparatus, or other devices to function in a particular manner, such that the instructions stored in the storage device produce an article of manufacture including instructions which implement the function or act specified in the schematic flowchart diagrams and/or schematic block diagrams.

The schematic flowchart diagrams and/or schematic block diagrams in the Figures illustrate the architecture, functionality, and operation of possible implementations of different apparatuses, systems, methods, and program products according to various embodiments. In this regard, each block in the schematic flowchart diagrams and/or schematic block diagrams may represent a module, segment, or portion of code, which includes one or more executable instructions of the code for implementing the specified logical function(s). One skilled in the relevant art will recognize, however, that the flowchart diagrams need not necessarily be practiced in the sequence shown and are able to be practiced without one or more of the specific steps, or with other steps not shown.

It should also be noted that, in some alternative implementations, the functions noted in the identified blocks may occur out of the order noted in the Figures. For example, two blocks shown in succession may, in fact, be substantially executed in concurrence, or the blocks may sometimes be executed in reverse order, depending upon the functionality involved.

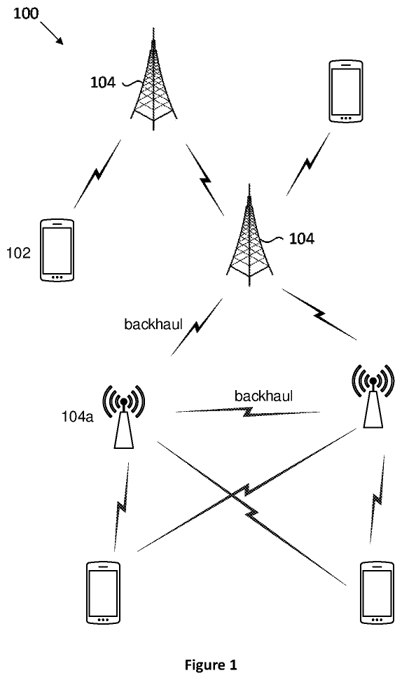

FIG. 1 is a schematic diagram illustrating a wireless communication system. It depicts an embodiment of a wireless communication system 100. In one embodiment, the wireless communication system 100 may include a user equipment (UE) 102 and a network equipment (NE) 104. Even though a specific number of UEs 102 and NEs 104 is depicted in FIG. 1, one skilled in the art will recognize that any number of UEs 102 and NEs 104 may be included in the wireless communication system 100.

The UEs 102 may be referred to as remote devices, remote units, subscriber units, mobiles, mobile stations, users, terminals, mobile terminals, fixed terminals, subscriber stations, user terminals, apparatus, devices, or by other terminology used in the art.

In one embodiment, the UEs 102 may be autonomous sensor devices, alarm devices, actuator devices, remote control devices, or the like. In some other embodiments, the UEs 102 may include computing devices, such as desktop computers, laptop computers, personal digital assistants (PDAs), tablet computers, smart phones, smart televisions (e.g., televisions connected to the Internet), set-top boxes, game consoles, security systems (including security cameras), vehicle on-board computers, network devices (e.g., routers, switches, modems), or the like. In some embodiments, the UEs 102 include wearable devices, such as smart watches, fitness bands, optical head-mounted displays, or the like. The UEs 102 may communicate directly with one or more of the NEs 104.

The NE 104 may also be referred to as a base station, an access point, an access terminal, a base, a Node-B, an eNB, a gNB, a Home Node-B, a relay node, an apparatus, a device, or by any other terminology used in the art. Throughout this specification, a reference to a base station may refer to any one of the above referenced types of the network equipment 104, such as the eNB and the gNB.

The NEs 104 may be distributed over a geographic region. The NE 104 is generally part of a radio access network that includes one or more controllers communicably coupled to one or more corresponding NEs 104. The radio access network is generally communicably coupled to one or more core networks, which may be coupled to other networks, like the Internet and public switched telephone networks. These and other elements of radio access and core networks are not illustrated, but are well known generally by those having ordinary skill in the art.

In one implementation, the wireless communication system 100 is compliant with a 3GPP 5G new radio (NR). In some implementations, the wireless communication system 100 is compliant with a 3GPP protocol, where the NEs 104 transmit using an OFDM modulation scheme on the DL and the UEs 102 transmit on the uplink (UL) using a SC-FDMA scheme or an OFDM scheme. More generally, however, the wireless communication system 100 may implement some other open or proprietary communication protocols, for example, WiMAX. The present disclosure is not intended to be limited to the implementation of any particular wireless communication system architecture or protocol.

The NE 104 may serve a number of UEs 102 within a serving area, for example, a cell (or a cell sector) or more cells via a wireless communication link. The NE 104 transmits DL communication signals to serve the UEs 102 in the time, frequency, and/or spatial domain.

Communication links are provided between the NE 104 and the UEs 102a, 102b, 102c, and 102d, which may be NR UL or DL communication links, for example. Some UEs 102 may simultaneously communicate with different Radio Access Technologies (RATs), such as NR and LTE. Direct or indirect communication link between two or more NEs 104 may be provided.

The NE 104 may also include one or more transmit receive points (TRPs) 104a. In some embodiments, the network equipment may be a gNB 104 that controls a number of TRPs 104a. In addition, there is a backhaul between two TRPs 104a. In some other embodiments, the network equipment may be a TRP 104a that is controlled by a gNB.

Communication links are provided between the NEs 104, 104a and the UEs 102, 102a, respectively, which, for example, may be NR UL/DL communication links. Some UEs 102, 102a may simultaneously communicate with different Radio Access Technologies (RATs), such as NR and LTE.

In some embodiments, the UE 102a may be able to communicate with two or more TRPs 104a that utilize a non-ideal backhaul, simultaneously. A TRP may be a transmission point of a gNB. Multiple beams may be used by the UE and/or TRP(s). The two or more TRPs may be TRPs of different gNBs, or a same gNB. That is, different TRPs may have the same Cell-ID or different Cell-IDs. The terms “TRP” and “transmitting-receiving identity” may be used interchangeably throughout the disclosure.

The technology disclosed, or at least some of the examples, may be applicable to scenarios with multiple TRPs or without multiple TRPs, as long as multiple PDCCH transmissions are supported.

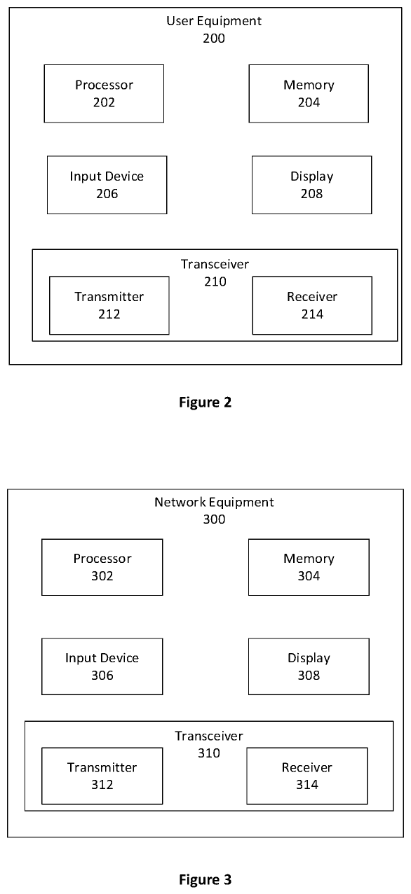

FIG. 2 is a schematic block diagram illustrating components of user equipment (UE) according to one embodiment. A UE 200 may include a processor 202, a memory 204, an input device 206, a display 208, and a transceiver 210. In some embodiments, the input device 206 and the display 208 are combined into a single device, such as a touchscreen. In certain embodiments, the UE 200 may not include any input device 206 and/or display 208. In various embodiments, the UE 200 may include one or more processors 202 and may not include the input device 206 and/or the display 208.

The processor 202, in one embodiment, may include any known controller capable of executing computer-readable instructions and/or capable of performing logical operations. For example, the processor 202 may be a microcontroller, a microprocessor, a central processing unit (CPU), a graphics processing unit (GPU), an auxiliary processing unit, a field programmable gate array (FPGA), or similar programmable controller. In some embodiments, the processor 202 executes instructions stored in the memory 204 to perform the methods and routines described herein. The processor 202 is communicatively coupled to the memory 204 and the transceiver 210.

The memory 204, in one embodiment, is a computer readable storage medium. In some embodiments, the memory 204 includes volatile computer storage media. For example, the memory 204 may include a RAM, including dynamic RAM (DRAM), synchronous dynamic RAM (SDRAM), and/or static RAM (SRAM). In some embodiments, the memory 204 includes non-volatile computer storage media. For example, the memory 204 may include a hard disk drive, a flash memory, or any other suitable non-volatile computer storage device. In some embodiments, the memory 204 includes both volatile and non-volatile computer storage media. In some embodiments, the memory 204 stores data relating to trigger conditions for transmitting the measurement report to the network equipment. In some embodiments, the memory 204 also stores program code and related data.

The input device 206, in one embodiment, may include any known computer input device including a touch panel, a button, a keyboard, a stylus, a microphone, or the like. In some embodiments, the input device 206 may be integrated with the display 208, for example, as a touchscreen or similar touch-sensitive display.

The display 208, in one embodiment, may include any known electronically controllable display or display device. The display 208 may be designed to output visual, audio, and/or haptic signals.

The transceiver 210, in one embodiment, is configured to communicate wirelessly with the network equipment. In certain embodiments, the transceiver 210 comprises a transmitter 212 and a receiver 214. The transmitter 212 is used to transmit UL communication signals to the network equipment and the receiver 214 is used to receive DL communication signals from the network equipment.

The transmitter 212 and the receiver 214 may be any suitable type of transmitters and receivers. Although only one transmitter 212 and one receiver 214 are illustrated, the transceiver 210 may have any suitable number of transmitters 212 and receivers 214. For example, in some embodiments, the UE 200 includes a plurality of the transmitter 212 and the receiver 214 pairs for communicating on a plurality of wireless networks and/or radio frequency bands, with each of the transmitter 212 and the receiver 214 pairs configured to communicate on a different wireless network and/or radio frequency band.

FIG. 3 is a schematic block diagram illustrating components of network equipment (NE) 300 according to one embodiment. The NE 300 may include a processor 302, a memory 304, an input device 306, a display 308, and a transceiver 310. As may be appreciated, the processor 302, the memory 304, the input device 306, the display 308, and the transceiver 310 may be similar to the processor 202, the memory 204, the input device 206, the display 208, and the transceiver 210 of the UE 200, respectively.

In some embodiments, the processor 302 controls the transceiver 310 to transmit DL signals or data to the UE 200. The processor 302 may also control the transceiver 310 to receive UL signals or data from the UE 200. In another example, the processor 302 may control the transceiver 310 to transmit DL signals containing various configuration data to the UE 200.

In some embodiments, the transceiver 310 comprises a transmitter 312 and a receiver 314. The transmitter 312 is used to transmit DL communication signals to the UE 200 and the receiver 314 is used to receive UL communication signals from the UE 200.

The transceiver 310 may communicate simultaneously with a plurality of UEs 200. For example, the transmitter 312 may transmit DL communication signals to the UE 200. As another example, the receiver 314 may simultaneously receive UL communication signals from the UE 200. The transmitter 312 and the receiver 314 may be any suitable type of transmitters and receivers. Although only one transmitter 312 and one receiver 314 are illustrated, the transceiver 310 may have any suitable number of transmitters 312 and receivers 314. For example, the NE 300 may serve multiple cells and/or cell sectors, where the transceiver 310 includes a transmitter 312 and a receiver 314 for each cell or cell sector.

With multiple TRPs, PDCCH for one DCI may be transmitted multiple times with different time, frequency, and/or spatial resources. Based on the principle for beam failure detection mechanism in Release 15, a beam failure event occurs when the quality of beam pair link(s) of an associated control channel falls low enough. With enhanced PDCCH transmission, the corresponding beam pair link(s) of the associated control channel will be improved by multiple transmissions and/or multiple beams. Thus, the beam failure detection mechanism could be enhanced to match newly introduced multiple PDCCH transmissions.

For beam failure detection, only a single PDCCH transmission is assumed for evaluating beam failure in Release 15 NR system. For PDCCH with multiple transmissions, the beam failure status needs to be determined by taking multiple transmissions and/or multiple beams into account.

In Release 15 or Release 16, only one (1) TCI state is activated for PDCCH transmission. Periodic Channel State Information Reference Signal (CSI-RS) resource set q̅₀̅ may be configured for beam failure detection, where at most two (2) beam failure detection resources are configured for a BWP of a serving cell. Link quality is evaluated based on measurement of each detection resource. When multiple beams from multiple TRPs are used for PDCCH transmission, link quality may be evaluated based on measurement on multiple reference signals (RSs). Thus, the beam failure detection resources for multiple PDCCH transmissions need be clarified in the cases where multiple transmit beams are used.

Signalling mechanism for aligning the assumption of hypothetical PDCCH transmission scheme for beam failure detection may be considered. With the introduction of the beam failure detection mechanism for multiple PDCCH transmissions, UE may have two kinds of behaviours for determining beam failure. The gNB and UE should have the same understanding of the assumed PDCCH transmission scheme for declaring beam failure event.

A UE may be provided, for each BWP of a serving cell, with a set q̅₀̅ of periodic CSI-RS resource configuration indexes by failureDetectionResources or beamFailureDetectionResourceList for radio link quality measurements on the BWP of the serving cell. Beam failure detection RS resource is configured by RadioLinkMonitoringConfig as shown in the following information element (IE). From the N_{LR-RLM} RadioLinkMonitoringRS, up to two RadioLinkMonitoringRS can be used for link recovery procedures. The UE expects the set q̅₀̅ to include up to two RS indexes. The UE expects single port RS in the set q̅₀̅.

RadioLinkMonitoringConfig information element

| | |
|---|---|
| RadioLinkMonitoringConfig ::= | SEQUENCE { |

```
  failureDetectionResourcesToAddModList SEQUENCE
(SIZE(1..maxNrofFailureDetectionResources)) OF RadioLinkMonitoringRS
OPTIONAL, -- Need N
  failureDetectionResourcesToReleaseList SEQUENCE
(SIZE(1..maxNrofFailureDetectionResources)) OF RadioLinkMonitoringRS-Id
OPTIONAL, -- Need N
```

| | |
|---|---|
| beamFailureInstanceMaxCount | ENUMERATED {n1, n2, n3, n4, n5, n6, n8, |
| n10} | OPTIONAL, -- Need R |
| beamFailureDetectionTimer | ENUMERATED {pbfd1, pbfd2, pbfd3, pbfd4, |
| pbfd5, pbfd6, pbfd8, pbfd10} | OPTIONAL, -- Need R |

...
}

| | |
|---|---|
| RadioLinkMonitoringRS ::= | SEQUENCE { |
| radioLinkMonitoringRS-Id | RadioLinkMonitoringRS-Id, |
| purpose | ENUMERATED {beamFailure, rlf, both}, |
| detectionResource | CHOICE { |
| ssb-Index | SSB-Index, |
| csi-RS-Index | NZP-CSI-RS-ResourceId |

```
  },
  ...
}
```

If the UE is not provided with q̅₀̅ by failureDetectionResources or beamFailureDetectionResourceList for a BWP of the serving cell, the UE determines the set q̅₀̅ to include periodic CSI-RS resource configuration indexes with same values as the RS indexes in the RS sets indicated by TCI-State for respective CORESETs that the UE uses for monitoring PDCCH, and if there are two RS indexes in a TCI state, the set q̅₀̅ includes RS indexes with QCL-TypeD configuration for the corresponding TCI states.

The UE shall assess the downlink link quality of a serving cell based on the reference signal in the set q̅₀̅ in order to detect beam failure instance. The RS resources in the set q̅₀̅ can be periodic CSI-RS resources and/or Synchronization Signal Block (SSB) resources. On each RS resource in the set q̅₀̅, the UE shall estimate the radio link quality and compare it to the threshold Q_{out,LR} for the purpose of accessing downlink radio link quality of the serving cell.

The threshold Q_{out,LR} corresponds to the default value of rlmInSyncOutOfSyncThreshold, i.e. the out-of-sync block error rate (BLERₒᵤₜ) of BLER threshold pair index for in/out of synchronization (IS/OOS) indication generation, where default value is 10%. The threshold Q_{out,LR} may be defined as the level at which the downlink radio level link cannot be reliably received and may correspond to the BLERₒᵤₜ=10% block error rate of a hypothetical PDCCH transmission.

For SSB based beam failure detection, Q_{out_LR_SSB} may be derived based on the hypothetical PDCCH transmission parameters as specified in TS 38.133. UE shall be able to evaluate whether the downlink radio link quality on the configured SSB resource in set q̅₀̅ estimated over the last T_{Evaluate_BFD_SSB} [ms] period becomes worse than the threshold Q_{out_LR_SSB} within T_{Evaluate_BFD_SSB} [ms] period. Similarly, for CSI-RS based beam failure detection, Q_{out_LR_CSI-RS} may be derived based on the hypothetical PDCCH transmission parameters as specified in TS 38.133. UE shall be able to evaluate whether the downlink radio link quality on the configured CSI-RS resource in set q̅₀̅ estimated over the last T_{Evaluate_BFD_CSI-RS} [ms] period becomes worse than the threshold Q_{out_LR_CSI-RS} within T_{Evaluate_BFD_CSI-RS} [ms] period.

In non-Discontinuous Reception (non-DRX) mode operation, the physical layer in the UE provides an indication to higher layers when the radio link quality for all corresponding resource configurations in the set q̅₀̅ that the UE uses to assess the radio link quality is worse than the threshold Q_{out,LR}. The physical layer informs the higher layers when the radio link quality is worse than the threshold Q_{out,LR} with a periodicity determined by the maximum between the shortest periodicity among the periodic CSI-RS configurations, and/or SS/PBCH blocks on the Primary Cell (PCell) or the Primary Secondary Cell (PSCell), in the set q̅₀̅ that the UE uses to assess the radio link quality and 2 milliseconds. In Discontinuous Reception (DRX) mode operation, the physical layer provides an indication to higher layers when the radio link quality is worse than the threshold Q_{out,LR} with a periodicity defined in TS 38.133.

In some examples, the number of instances of beam failure detected within a period (e.g. beamFailureDetectionTimer) may be counted, and a beam failure recovery procedure or a random access procedure may be triggered once the number reaches a preset maximum value (e.g. beamFailurelnstanceMaxCount). Behaviour of MAC entity for each Serving Cell configured for beam failure detection is defined in TS 38.321 as follows. The present disclosure is mainly directed to the beam failure detection scheme/procedure in the physical layer. For MAC layer processing of physical layer reporting, the current scheme/procedure can be reused as the following table defined in TS 38.321.

The MAC entity shall for each Serving Cell configured for beam failure detection:

| 1> | if beam failure instance indication has been received from lower layers: | |
|---|---|---|
| | 2> | start or restart the beamFailureDetectionTimer; |
| | 2> | increment BFI_COUNTER by 1; |
| | 2> | if BFI_COUNTER >= beamFailureInstanceMaxCount: |

| 3> | if the Serving Cell is SCell: |
|---|---|
| | 4> trigger a BFR for this Serving Cell; |
| 3> | else: |

4> initiate a Random Access procedure on the SpCell.

| 1> | if the beamFailureDetectionTimer expires; or | |
|---|---|---|
| 1> | if beamFailureDetectionTimer, beamFailureInstanceMaxCount, or any of the reference | |
| | signals used for beam failure detection is reconfigured by upper layers associated with | |
| | this Serving Cell: | |
| | 2> | set BFI_COUNTER to 0. |
| 1> | if the Serving Cell is SpCell and the Random Access procedure is successfully | |
| | completed: | |
| | 2> | set BFI_COUNTER to 0; |
| | 2> | stop the beamFailureRecoveryTimer, if configured; |
| | 2> | consider the Beam Failure Recovery procedure successfully completed. |

| | |
|---|---|
| 1> | else if the Serving Cell is SCell, and a PDCCH addressed to C-RNTI indicating uplink |
| | grant for a new transmission is received for the HARQ process used for the transmission |
| | of the SCell BFR MAC CE or truncated SCell BFR MAC CE which contains beam |
| | failure recovery information of this Serving Cell |

Enhanced configuration and implicit determination principle for beam failure detection resources are proposed in view of multiple transmission beams. Threshold and transmission parameters for hypothetical PDCCH transmission scheme are defined based on multiple PDCCH transmissions. Moreover, the signalling is introduced to align gNB and UE on the assumption of PDCCH transmission scheme for beam failure evaluation.

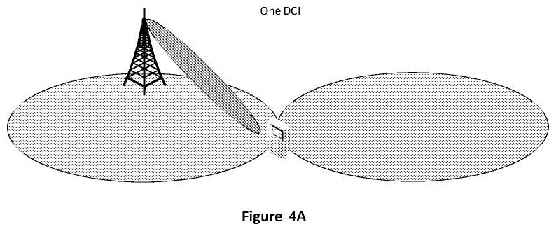

Two exemplary systems of multiple transmissions of PDCCH for a DCI using multiple TRPs are shown in FIGS. 4A and 4B. One DCI is transmitted with multiple times of repeat transmission from multiple TRPs 410, 420 to UE 430 with each repeating transmission monitored on one PDCCH monitoring occasion.

Based on the actual application scenario, one or more CORESETs may be configured for PDCCH transmission. In the case of one CORESET configuration as shown in FIG. 4A with CORESET 0 only, multiple times of DCI repetition are transmitted in multiple monitoring occasions in one search space set (search space k). The multiple PDCCH transmissions may be from a single CORESET (CORESET 0) with multiple TCI states (e.g. TCI state 1 and TCI state 2).

In the case of multiple CORESETs configuration as shown in FIG. 4B with CORESET 0 and CORESET 1, multiple times of DCI repetition are transmitted in multiple monitoring occasions in multiple search space sets (search space k and search space k+1). The multiple PDCCH transmissions may be from multiple CORESETs (CORESET 0 and CORESET 1) with one TCI state for each CORESET (e.g. TCI state 1 for CORESET 0 and TCI state 2 for CORESET 1).

In some examples, only two PDCCH monitoring occasions (Occasion 1 and Occasion 2) in a slot may be supported for two repetitions; in some other examples, four PDCCH monitoring occasions (Occasions 1, 2, 3, and 4) in a slot may be supported for four repetitions. Several transmission pattern for TCI states are possible, e.g. [1 2] or [1 1 2 2] if two TCI states are used for multiple PDCCH transmissions, and [1 1] or [1 1 1 1] if only one TCI state is used for multiple PDCCH transmissions. Here, the numbers ‘1’ and ‘2’ in ‘[1 2]’ refer to TCI state 1 for the first transmission and TCI state 2 for the second transmission, respectively.

### Beam Failure Detection Resources

For Release 15/Release 16 beam failure detection, only one configured detection resource or one detection resource linked with PDCCH monitoring is used for one candidate link quality evaluation, where PDCCH is assumed to be transmitted only one (1) time. For PDCCH enhancement in Release 17, multiple times of PDCCH transmission may be introduced for one DCI, where different TCI states may be used for multiple time transmissions. Thus, multiple beam failure detection resources may be used jointly for one candidate link quality evaluation.

In some examples, if the beam failure detection RS set q̅₀̅ is configured, combined detection resources (i.e., a beam failure detection resource combination including a number of beam failure detection resources) may be configured with multiple SSB and/or CSI-RS resources for joint link quality evaluation for PDCCH with multiple time transmissions. The UE may receive a configuration signaling that configures the beam failure detection RS set q̅₀̅ and determine the beam failure detection resource combination based on the configuration signaling.

When RadioLinkMonitoringRS is used for configuring detection resources for beam failure detection, an additional parameter detectionResourceCombination may be introduced, where there are maxNrofdetectionResourcePerCombination (e.g. 2) detection resources for joint link quality evaluation. An example of the information element is illustrated below for Radio Resource Control (RRC) signaling design.

RRC IE design for jointly multiple RS for beam failure detection

| | |
|---|---|
| RadioLinkMonitoringRS ::= | SEQUENCE { |
| radioLinkMonitoringRS-Id | RadioLinkMonitoringRS-Id, |
| purpose | ENUMERATED {beamFailure, rlf, both}, |

detectionResourceCombination SEQUENCE (SIZE
(1..maxNrofdetectionResourcePerCombination)) OF detectionResource OPTIONAL,
-- Cond beamFailure

| | |
|---|---|
| detectionResource | CHOICE { |
| ssb-Index | SSB-Index, |
| csi-RS-Index | NZP-CSI-RS-ResourceId |
| repeat-Num | ENUMERATED {n1, n2, n4, n8} OPTIONAL |

},
}
maxNrofdetectionResourcePerCombination INTEGER ::= 2

New candidate beam list is introduced in Release 16 for Secondary Cell (SCell) beam failure detection. Similar design may be used for beamFailureDetectionResourceList, where beamFadureDetectionResourceCombination is introduced in the beamFailureDetectionResourceList to support multiple beams for joint SCell link quality evaluation. An example of the information element is illustrated below for RRC signaling design.

RRC IE design of jointly multiple RS for Release 16 enhanced beam failure detection

BeamFailureRecoverySCellConfig-r16 ::= SEQUENCE {
...

| | |
|---|---|
| beamFailureDetectionResourceList | SEQUENCE |

(SIZE(1..maxNrofCandidateBeams)) OF beamFailureDetectionResourceCombination
OPTIONAL, -- Need M
...
}

| | |
|---|---|
| beamFailureDetectionResourceCombination ::= | SEQUENCE { |

beamFailureDetectionResource SEQUENCE (SIZE
(1..maxNrofcandidateBeamRSPerCombination)) OF detectionResource-r16

| | |
|---|---|
| detectionResource-r16 | CHOICE { |
| ssb-Index | SSB-Index, |
| csi-RS-Index | NZP-CSI-RS-ResourceId |
| repeat-Num | ENUMERATED {n1, n2, n4, n8} OPTIONAL |

},

| | |
|---|---|
| servingCellId | ServCellIndex |

OPTIONAL -- Need R
}
maxNrofcandidateBeamRSPerCombination INTEGER ::= 2

Since same or different TCI states may be used for PDCCH with multiple transmissions, repeat number (i.e., the number of PDCCH transmissions for one DCI) may be configured for each beam failure detection RS separately. It may be used for evaluating link quality used by hypothetical PDCCH transmission scheme. As an example of realization, an optional signalling of repeat-Num may be added in the beam failure detection resources configuration as shown in the above RRC IE designs.

In some other examples, where the beam failure detection RS set q̅₀̅ is not configured, detection resources corresponding to multiple activated TCI states for PDCCH monitoring are used for joint link quality evaluation. The UE may determine a beam failure detection resource combination implicitly from resources with a same TCI state as one of multiple activated TCI states for PDCCH monitoring.

If the UE is not provided with q̅₀̅ by failureDetectionResources or beamFailureDetectionResourceList for a BWP of the serving cell, the UE determines the set q̅₀̅ to include periodic CSI-RS resource configuration indexes with same values as the RS indexes in the RS sets indicated by TCI-State for respective CORESETs that the UE uses for monitoring PDCCH. If there are two RS indexes in a TCI state, the set q̅₀̅ includes RS indexes with QCL-TypeD configuration for the corresponding TCI states.

When multiple CORESETs are configured to monitor PDCCH for one DCI transmission and one TCI state is activated for each CORESET, the detection resources corresponding to activated TCI states for multiple CORESETs may be set in W jointly for link quality evaluation.

Similar, when a single CORESET with multiple activated TCI states is configured to monitor PDCCI for one DCI transmission, the detection resources corresponding to multiple activated TCI states may be set in q̅₀̅ jointly for link quality evaluation.

The UE uses the same assumption of the number of repetitions transmitted per DCI (i.e., the number of PDCCH transmissions for one DCI) in the single or multiple CORESETs when assessing whether the quality of the beam (or beam pair) has degraded to 10% BLER. TCI states for PDCCH monitoring may be changed by MAC CE. However, link recovery has a joint Layer 1+Layer 2 procedure and link quality evaluation needs a duration for robustness requirement. Thus, it may not be preferred to support fast switching for link quality evaluation assumption between single time PDCCH transmission and multiple time PDCCH transmission. When the link quality evaluation is made based on hypothetical multiple PDCCH transmissions but only one TCI state is used for one actual PDCCH transmission or only one TCI state for the hypothetical multiple PDCCH is updated, two alternatives may be used for UE to determine detection resources in set q̅₀̅. In one example, detection resources corresponding to TCI states for previous multiple time PDCCH transmissions may be set to q̅₀̅. That is, the beam failure detection resources correspond to last used TCI states for the multiple transmissions of PDCCH. Alternatively, detection resources corresponding to the newest TCI states for each CORESET used for multiple PDCCH transmission may be set to q̅₀̅. That is, each one of the beam failure detection resources corresponds to a newest TCI state for each CORESET that is used for the multiple transmissions of PDCCH.

### Beam Failure Detection Procedure

The physical layer in the UE assesses the radio link quality according to the set q̅₀̅ of resource configurations against the threshold Q_{out,LR} The threshold Q_{out,LR} may be defined as the level at which the downlink radio level link cannot be reliably received and shall correspond to the BLERₒᵤₜ=10% block error rate of a hypothetical PDCCH transmission. Since one DCI is actually transmitted by PDCCH with multiple times, it is better to make it as hypothetical PDCCH transmission to match the actual downlink radio link quality. The target of BLERₒᵤₜ=10% block error rate may not be changed since it is well-defined and used for Release 15 or Release 16 NR system. Thus, an additional threshold Q_{out,LR} is proposed to be derived based on the target of BLERₒᵤₜ=10% block error rate for hypothetical PDCCH with multiple transmissions.

In some examples, the threshold Q_{out,LR} for a hypothetical PDCCH with multiple transmissions may be defined by modifying the definition of the threshold Q_{out,LR} in Release 15 or Release 16 in TS 38.133.

In view of PDCCH transmission with multiple times, the threshold Q_{out,LR} may

The threshold Q_{out,LR} is defined as the level at which the downlink radio level link
cannot be reliably received and shall correspond to the BLERₒᵤₜ=10% block error
rate of a hypothetical PDCCH transmission with one or multiple times. For SSB
based beam failure detection, Qₒᵤₜ_{_{—}}_{LR}_{_{—}}_{SSB} is derived based on the hypothetical
PDCCH transmission parameters listed in Table 8.5.2.1-1. For CSI-RS based
beam failure detection, Qₒᵤₜ_{_{—}}_{LR}_{_{—}}_{CSI-RS} is derived based on the hypothetical PDCCH
transmission parameters listed in Table 8.5.3.1-1.

be redefined as follows.

The number of PDCCH transmission times and related TCI state switching pattern may also be added in the PDCCH transmission parameter list, as shown in Table 1 (updated based on Table 8.5.2.1-1 in TS 38.133) for SSB as detection resource and Table 2 (updated based on Table 8.5.3.1-1 in TS 38.133) for CSI-RS as detection resource, for example. For one beam failure detection instance, the UE makes measurement on joint configured resources linked with multiple transmissions. Based on implementation algorithm, it derives equivalent Q value (i.e. a value reflecting the link quality) based on measurement results, where each transmission is linked with a measurement result. The UE may judge whether beam failure happens for this instance by comparing equivalent Q to the threshold Q_{out,LR}. That is, after determining the beam failure detection resource combination, or the beam failure detection resource, the UE receives signals from at least one of the beam failure detection resources, and determines a link quality based on measurements of the signals received. The UE may generate a beam failure evaluation report based on the link quality and the threshold Q_{out,LR}.

TABLE 1
PDCCH transmission parameters for beam failure instance

| Attribute | Value for BLER |
|---|---|
| DCI format | 1-0 |
| Number of control OFDM | 2 |
| symbols | |
| Aggregation level (CCE) | 8 |
| Ratio of hypothetical PDCCH RE | 0 dB |
| energy to average SSS RE energy | |
| Ratio of hypothetical PDCCH | 0 dB |
| DMRS energy to average SSS RE | |
| energy | |
| Bandwidth (MHz) | TBD |
| Sub-carrier spacing (kHz) | Same as the SCS of RMSI |
| | CORESET |
| DMRS precoder granularity | REG bundle size |
| REG bundle size | 6 |
| CP length | Normal |
| Mapping from REG to CCE | Distributed |
| Number of PDCCH transmission | 2 or 4 as configured PDCCH |
| | transmission number |
| TCI switching pattern | [1 2] or [1 1 2 2] if 2 TCI for |
| | multiple PDCCH transmissions |
| | [1 1] or [1 1 1 1] if only 1 TCI for |
| | multiple PDCCH transmissions |
| | (Note: ‘1 2’ means TCI state 1 for the |
| | first transmission and TCI state 2 for |
| | the second transmission) |

TABLE 2
PDCCH transmission parameters for beam failure instance

| Attribute | Value for BLER |
|---|---|
| DCI format | 1-0 |
| Number of control OFDM | 2 |
| symbols | |
| Aggregation level (CCE) | 8 |
| Ratio of hypothetical PDCCH | 0 dB |
| RE energy to average CSI-RS | |
| RE energy | |
| Ratio of hypothetical PDCCH | 0 dB |
| DMRS energy to average CSI-RS | |
| RE energy | |
| Bandwidth (MHz) | TBD |
| Sub-carrier spacing (kHz) | TBD |
| DMRS precoder granularity | REG bundle size |
| REG bundle size | 6 |
| CP length | Normal |
| Mapping from REG to CCE | Distributed |
| Number of PDCCH transmission | 2 or 4 as configured PDCCH |
| | transmission number |
| TCI switching pattern | [1 2] or [1 1 2 2] if 2 TCI for |
| | multiple PDCCH transmissions |
| | [1 1] or [1 1 1 1] if only 1 TCI for |
| | multiple PDCCH transmissions |
| | (Note: ‘1 2’ means TCI state 1 for the |
| | first transmission and TCI state 2 for |
| | the second transmission) |

The thresholds Q_{out,LR} and Q_{in,LR} correspond to the default value of rlmInSyncOutOfSyncThreshold, as described in TS 38.133 for Qₒᵤₜ, and to the value provided by rsrp-ThresholdSSB or rsrp-ThresholdSSBBFR, respectively. For determining the threshold Q_{out,LR}, the number of PDCCH transmissions and/or a TCI state switching pattern for a hypothetical PDCCH with multiple transmissions may be configured/predefined, or alternatively the configured value as that for actual PDCCH transmission may be reused.

As an example of configuration for a hypothetical PDCCH with multiple transmissions, the number of PDCCH transmissions may be 2 or 4. The TCI state switching pattern may be [1 2] or [1 1 2 2] for 2 activated TCI states with 2 or 4 transmissions and [1 1] or [1 1 1 1] for 1 activated TCI state with 2 or 4 transmissions. In some examples, multiple times of transmission of PDCCH with a single TCI state can serve as one hypothetical PDCCH transmission scheme. In this case, there is no need of enhancement for beam failure detection resources. As shown in Table 2, the number of PDCCH transmission may be predefined to align understanding between gNB and UE. Thus, for the case of only one TCI state, the TCI switching pattern (i.e. 1 1] or [1 1 1 1]) may not be required.

It is noted that there are multiple candidate PDCCH transmission schemes (or hypothetical PDCCH transmission schemes), which include Release 15 or Release 16 PDCCH transmission scheme and enhanced multiple PDCCH transmission scheme. If different hypothetical PDCCH transmission schemes are assumed, different thresholds Q_{out,LR} will be used at the UE side to evaluate beam failure status. Thus, it may be desirable to have the same understanding on the assumed hypothetical PDCCH transmission scheme for beam failure detection. The actual PDCCH transmission scheme used may be related with UE capability and actual system status, e.g. system PDCCH load. Specifically, the UE may report its capability indicating whether it can support the enhanced beam failure detection scheme (e.g. beam failure detection with hypothesis of multiple PDCCH transmissions). The reported capability may further include the supported detection RS/RS combination number and the component RS number in one RS combination. The gNB has the capability to select the PDCCH transmission scheme based on UE reported capability and actual system load status. Thus, a signalling may be introduced to indicate UE the hypothetical PDCCH transmission scheme for beam failure detection. For example, a 1-bit signalling may be used to indicate whether the hypothetical PDCCH transmission scheme is normal Release 15/Release 16 PDCCH transmission scheme or enhanced Release 17 PDCCH multiple times transmission scheme.

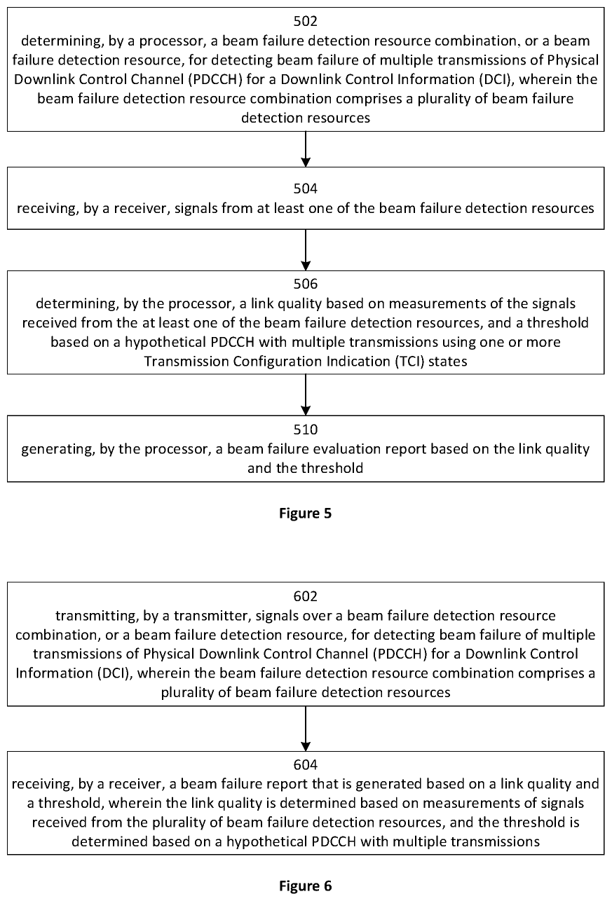

FIG. 5 is a flow chart illustrating steps of beam failure detection mechanism for enhanced PDCCH with multiple transmissions by UE in accordance with some implementations of the present disclosure.

At step 502, the processor 202 of UE 200 determines a beam failure detection resource combination, or a beam failure detection resource, for detecting beam failure of multiple transmissions of Physical Downlink Control Channel (PDCCH) for a Downlink Control Information (DCI), wherein the beam failure detection resource combination comprises a plurality of beam failure detection resources.

At step 504, the receiver 214 of UE 200 receives signals from at least one of the beam failure detection resources.

At step 506, the processor 202 of UE 200 determines a link quality based on measurements of the signals received from the at least one of the beam failure detection resources, and a threshold based on a hypothetical PDCCH with multiple transmissions using one or more Transmission Configuration Indication (TCI) states.

At step 510, the processor 202 of UE 200 generates a beam failure evaluation report based on the link quality and the threshold.

FIG. 6 is a flow chart illustrating steps of beam failure detection mechanism for enhanced PDCCH with multiple transmissions by NE in accordance with some implementations of the present disclosure.

At step 602, the transmitter 312 of NE 300 transmits signals over a beam failure detection resource combination, or a beam failure detection resource, for detecting beam failure of multiple transmissions of Physical Downlink Control Channel (PDCCH) for a Downlink Control Information (DCI), wherein the beam failure detection resource combination comprises a plurality of beam failure detection resources.

At step 604, the receiver 314 of NE 300 receives a beam failure report that is generated based on a link quality and a threshold, wherein the link quality is determined based on measurements of signals received from the plurality of beam failure detection resources, and the threshold is determined based on a hypothetical PDCCH with multiple transmissions.

Various embodiments and/or examples are disclosed to provide exemplary and explanatory information to enable a person of ordinary skill in the art to put the disclosure into practice. Features or components disclosed with reference to one embodiment or example are also applicable to all embodiments or examples unless specifically indicated otherwise.

Embodiments may be practiced in other specific forms. The described embodiments are to be considered in all respects only as illustrative and not restrictive. The scope is, therefore, indicated by the appended claims rather than by the foregoing description. All changes which come within the meaning and range of equivalency of the claims are to be embraced within their scope.

1. An apparatus, comprising:
a processor that determines a beam failure detection resource combination, or a beam failure detection resource, for detecting beam failure of multiple transmissions of Physical Downlink Control Channel (PDCCH) for a Downlink Control Information (DCI), wherein the beam failure detection resource combination comprises a plurality of beam failure detection resources; and
a receiver that receives signals from at least one of the beam failure detection resources;
wherein the processor further determines a link quality based on measurements of the signals received from the at least one of the beam failure detection resources, and a threshold based on a hypothetical PDCCH with multiple transmissions using one or more Transmission Configuration Indication (TCI) states; and
the processor further generates a beam failure evaluation report based on the link quality and the threshold.

2. The apparatus of claim 1, wherein the receiver further receives a configuration signaling, and the processor determines the beam failure detection resource combination based on the configuration signaling.

3. The apparatus of claim 1, wherein the plurality of beam failure detection resources comprise Channel State Information Reference Signal (CSI-RS) resources, and/or Synchronization Signal Block (SSB) resources.

4. The apparatus of claim 1, wherein the processor determines the beam failure detection resource combination implicitly from resources with a same TCI state as one of multiple activated TCI states for PDCCH monitoring.

5. The apparatus of claim 4, wherein each one of the beam failure detection resources corresponds to a newest TCI state for each CORESET that is used for the multiple transmissions of PDCCH.

6. The apparatus of claim 4, wherein the beam failure detection resources correspond to last used TCI states for the multiple transmissions of PDCCH.

7. The apparatus of claim 1, wherein the processor further determines a hypothetical PDCCH transmission parameter list comprising a number of PDCCH transmissions for a DCI and/or a TCI state switching pattern of the PDCCH transmissions.

8. The apparatus of claim 1, wherein the receiver further receives a signaling indicating a hypothetical PDCCH transmission scheme for the multiple transmissions of PDCCH.

9. The apparatus of claim 1, further comprising a transmitter that transmits a capability report indicating whether beam failure detection with hypothesis of multiple PDCCH transmissions is supported.

10. An apparatus, comprising:
a transmitter that transmits signals over a beam failure detection resource combination, or a beam failure detection resource, for detecting beam failure of multiple transmissions of Physical Downlink Control Channel (PDCCH) for a Downlink Control Information (DCI), wherein the beam failure detection resource combination comprises a plurality of beam failure detection resources; and
a receiver that receives a beam failure report that is generated based on a link quality and a threshold, wherein the link quality is determined based on measurements of signals received from the plurality of beam failure detection resources, and the threshold is determined based on a hypothetical PDCCH with multiple transmissions.

11. The apparatus of claim 10, wherein the transmitter further transmits a configuration signaling for determining the beam failure detection resource combination.

12. The apparatus of claim 10, wherein the plurality of beam failure detection resources comprise Channel State Information Reference Signal (CSI-RS) resources, and/or Synchronization Signal Block (SSB) resources.

13. The apparatus of claim 10, wherein the transmitter further transmits a signaling indicating a hypothetical PDCCH transmission scheme for the multiple transmissions of PDCCH.

14. The apparatus of claim 10, wherein the receiver further receives a capability report indicating whether beam failure detection with hypothesis of multiple PDCCH transmission is supported.

15. A method, comprising:
determining, by a processor, a beam failure detection resource combination, or a beam failure detection resource, for detecting beam failure of multiple transmissions of Physical Downlink Control Channel (PDCCH) for a Downlink Control Information (DCI), wherein the beam failure detection resource combination comprises a plurality of beam failure detection resources; and
receiving, by a receiver, signals from at least one of the beam failure detection resources;
determining, by the processor, a link quality based on measurements of the signals received from the at least one of the beam failure detection resources, and a threshold based on a hypothetical PDCCH with multiple transmissions using one or more Transmission Configuration Indication (TCI) states; and
generating, by the processor, a beam failure evaluation report based on the link quality and the threshold.

16. The method of claim 15, wherein the receiver further receives a configuration signaling, and the processor determines the beam failure detection resource combination based on the configuration signaling.

17. The method of claim 15, wherein the plurality of beam failure detection resources comprise Channel State Information Reference Signal (CSI-RS) resources, and/or Synchronization Signal Block (SSB) resources.

18. The method of claim 15, wherein the processor determines the beam failure detection resource combination implicitly from resources with a same TCI state as one of multiple activated TCI states for PDCCH monitoring.

19. The method of claim 18, wherein each one of the beam failure detection resources corresponds to a newest TCI state for each CORESET that is used for the multiple transmissions of PDCCH.

20. The method of claim 18, wherein the beam failure detection resources correspond to last used TCI states for the multiple transmissions of PDCCH.

21. (canceled)

22. (canceled)

23. (canceled)

24. (canceled)

25. (canceled)

26. (canceled)

27. (canceled)

28. (canceled)
